(19) United States
(12) Patent Application Publication
(10) Pub. No.: US 2014/0306167 A1
(43) Pub. Date: Oct. 16, 2014

(54) SILVER POWDER, METHOD FOR PRODUCING SILVER POWDER, AND CONDUCTIVE PASTE

(71) Applicant: SUMITOMO METAL MINING CO., LTD., Tokyo (JP)

(72) Inventors: Toshiaki Terao, Ehime (JP); Eiji Ishida, Ehime (JP)

(73) Assignee: SUMITOMO METAL MINING CO., LTD.

(21) Appl. No.: 14/356,280

(22) PCT Filed: Nov. 15, 2012
(86) PCT No.: PCT/JP2012/079634

§ 371 Date: May 5, 2014

(30) Foreign Application Priority Data
Nov. 18, 2011 (JP) 2011-252922

(51) Int. Cl. H01B 1/22; B22F 1/00; B22F 9/24

(52) U.S. Cl. CPC H01B 1/22; B22F 9/24; B22F 1/0003
USPC 252/514; 75/370; 420/501

(57) ABSTRACT

The present invention provides a method for producing silver powder having a low content of chlorine, and provides a conductive paste containing the obtained silver powder. In the case where silver powder is obtained in such a manner that a solution containing a silver complex obtained by dissolving silver chloride with a complexing agent is mixed with a reducing agent solution to reduce the silver complex, an organic compound having a hydrophilic group which is positively charged when ionized in water is added to both the solution containing the silver complex and the reducing agent solution, or added to either the solution containing the silver complex or the reducing agent solution, whereby adsorption of the organic compound onto the surfaces of silver particles precedes adsorption of chlorine thereonto, and thus adsorption of chlorine onto silver particles is controlled.

### FIELD OF THE INVENTION

The present invention relates to silver powder, a method for producing said silver powder, and a conductive paste containing said silver powder, more particularly, relates to silver powder as a main ingredient of a silver paste used for forming a wiring layer, an electrode, and the like of electronic devices; a method for producing said silver powder; and a conductive paste containing said silver powder.

The present application asserts priority rights based on JP Patent Application 2011-252922 filed in Japan on Nov. 18, 2011. The total contents of disclosure of the Patent Application of the senior filing date are to be incorporated by reference into the present Application.

### BACKGROUND OF THE INVENTION

In order to form the wiring layer, the electrode, and the like of electronic devices, the silver paste, such as a resin type silver paste, or a baked type silver paste has been widely used. A conductive film of the wiring layer, the electrode, or the like is formed in such a manner that the silver paste is applied or printed, and then heat-cured or heat-baked.

For example, the resin type silver paste comprises silver powder, a resin, a curing agent, a solvent, and the like, and this resin type silver paste is printed on a conductor circuit pattern or a terminal, and then heat-cured at a temperature of 100 to 200 degrees C. to be made into a conductive film, whereby the wiring layer, the electrode, or the like is formed. Meanwhile, the baked type silver paste comprises silver powder, glass, a solvent, and the like, and this baked type silver paste is printed on a conductor circuit pattern or a terminal, and then heat-baked at a temperature of 600 to 800 degrees C. to be made into a conductive film, whereby the wiring layer, the electrode, or the like is formed. The conductivity of these wiring layer, electrode, and the like which are formed by heating the silver paste depends on sintering characteristics of silver powder.

Silver powder here can be produced in such a manner that silver chloride or silver nitrate is used as a starting material, and a silver complex solution containing a silver complex obtained by dissolving this silver chloride or silver nitrate by a complexing agent is mixed with a reducing agent solution, and then silver particles resulting from the reduction of the silver complex are washed and dried. In the case where silver nitrate is used as a starting material, it is necessary to install equipment of collecting nitrous acid gas or equipment of treating nitrate nitrogen contained in waste water. On the other hand, in the case where silver chloride is used, such equipment is not needed, whereby a production cost can be reduced and the influence on environment is reduced. Hence, for producing silver powder, silver chloride is preferably used as a starting material. However, using the silver chloride causes chlorine to be contained as an impurity in silver powder.

Sintering characteristics of silver powder are affected by a surface form of silver powder and a surface treatment thereof, but are also greatly affected by impurities, such as chlorine, which inhibit sintering. Particularly, it is easily for silver to form a halogen element, such as chlorine, and a silver salt. Silver salts have a higher decomposition temperature, thereby inhibiting sintering, and furthermore, serving as a non-conductive substance to increase the resistance of the wiring layer, the electrode, and the like. Even a minute amount, such as approximately 100 ppm, of a silver salt, particularly chlorine, causes a problem in sintering characteristics.

Therefore, in a method for producing silver powder using silver chloride which needs no special equipment as a starting material, which is unlike in the case of using silver nitrate, reduction in the chlorine content of the silver powder has been required.

### PRIOR-ART DOCUMENTS

### Patent Document

PTL 1: Japanese Patent Application Laid-Open No. 2000-129318

### SUMMARY OF THE INVENTION

Therefore, the present invention is proposed in view of such actual circumstances, and aims to provide silver powder having a low content of chlorine, a method for producing said silver powder, and a conductive paste containing said silver powder.

The inventors of the present invention earnestly studied to achieve the above-mentioned purpose, and as a result, found that, in a process to produce silver powder by reducing a silver complex, at the time of reduction, the presence of an organic compound having a hydrophilic group which is positively charged when ionized in water allows an amount of chlorine in silver powder to be reduced.

In other words, a method for producing silver powder according to the present invention is such that a solution containing a silver complex obtained by dissolving silver chloride with a complexing agent is mixed with a reducing agent solution, and the above-mentioned silver complex is reduced to obtain silver powder, wherein an organic compound having a hydrophilic group which is positively charged when ionized in water is added to both the solution containing the silver complex and the reducing agent solution, or added to either the solution containing the silver complex or the reducing agent solution.

Also, the present invention provides silver powder, wherein a solution containing a silver complex obtained by dissolving silver chloride with a complexing agent is mixed with a reducing agent solution, an organic compound having a hydrophilic group which is positively charged when ionized in water adsorbs onto the surfaces of silver particles which are obtained by reducing the silver complex, and the concentration of chlorine in the silver powder is 0.003% or less by mass.

Also, a conductive paste according to the present invention contains the above-mentioned silver powder as a conductor.

### Effects of Invention

According to the present invention, the chlorine content of g is 0.003% or less by mass, and thus such small content of chlorine allows silver powder excellent in sintering characteristics to be obtained. Thus, in the present invention, using the conductive paste containing the silver powder makes it possible to form the wiring layer, the electrode, and the like, each being excellent in conductivity.

### DETAILED DESCRIPTION OF THE INVENTION

Hereinafter, a method for producing silver powder according to the present invention, silver powder obtained by said method for producing silver powder, and a conductive paste containing said silver powder will be explained in detail. It should be noted that the present invention is not particularly limited to the following detailed explanation as long as there is no limitation.

Silver powder is contained in the resin type silver paste comprising a curing agent, a resin, a solvent, and the like or in the baked type silver paste comprising glass, a solvent, and the like. The resin type silver paste and the baked type silver paste, each containing silver powder, are used for formation of the wiring layer, the electrode, and the like. Sintering characteristics of silver powder plays an important role in the conductivity of the wiring layer, the electrode, and the like, and therefore it is necessary to use silver powder containing a small amount of chlorine which inhibits sintering of silver powder. Silver powder according to the present embodiment has a chlorine content of 0.003% or less by mass, and thus the chlorine content therein is small, whereby sintering characteristics thereof is good.

The silver powder preferably has a mean primary-particle diameter DS of 0.1 μm to 1.5 μm, more preferably 0.4 μm to 1.2 μm, the mean primary particle diameter DS being measured by scanning electron microscope (SEM) observation. Silver powder having a mean primary-particle diameter of 0.1 μm or more allows resistance not to be produced and conductivity to be made good when the silver powder is made into a silver paste (a conductive paste). Meanwhile, silver powder having a mean primary particle diameter of 1.5 μm or less allows dispersibility not to be worsened, silver flake not to be produced in a kneading process, and printing characteristics to be made good.

Furthermore, the mean particle diameter of silver powder is preferably a D50 (volume integral 50% diameter) of 0.5 μm to 5 μm, more preferably a D50 of 1.0 μm to 4.0 μm, the D50 being measured by laser diffraction scattering. When a D50 is within this range, silver powder can be preferably used for the silver paste, and dispersibility of silver powder in the paste is improved. A D50 of less than 0.5 μm may cause aggregation of silver particles during kneading the paste, thereby causing generation of flake, and thus kneading properties can be decreased. Meanwhile, a D50 of more than 5 μm causes excessive aggregation of silver particles, thereby forming a great amount of large-size aggregation, whereby dispersion stability of the paste in a solvent may be worsened.

A method for producing silver powder according to the present embodiment uses silver chloride as a starting material. First, a process for forming silver particle slurry by a wet reduction method is performed, the wet reduction method being such that a silver complex solution containing a silver complex obtained by dissolving silver chloride with a complexing agent is mixed with a reducing agent solution, and the silver complex is reduced to precipitate the silver particles. This process for forming silver particle slurry does not need to install equipment of collecting nitrous acid gas and equipment of treating nitrate nitrogen contained in waste water, both of the equipment being needed in prior methods using silver nitrate as a starting material, and also the process has less influence on environment, and therefore reduction in production cost can be achieved. Furthermore, in the case where silver nitrate is used as a starting material, nitrate ions are contained in silver powder, and therefore the presence of nitrate ions causes effects, such as worsening of sintering characteristics of silver powder, meanwhile, in the case where silver chloride is used, nitrate ions are not contained and therefore there are not such effects. Thus, using the silver chloride can control the mixing of nitrate ions into silver powder, better than using the silver nitrate.

Specifically, in the process for forming silver particle slurry, first, silver chloride is dissolved by using a complexing agent, whereby a silver complex solution containing a silver complex is prepared. The complexing agent is not particularly limited, but there is preferably used aqueous ammonia which easily forms silver chloride and a complex and does not contain a component which is to remain as an impurity. Also, as the silver chloride, high-purity silver chloride is preferably used. As such silver chloride, high-purity silver chloride has been stably manufactured for industrial use.

The method for dissolving silver chloride is such that, for example, in the case where aqueous ammonia is used as a complexing agent, silver chloride slurry may be produced and then aqueous ammonia may be added thereto, but, in order to increase the concentration of a complex and thereby to raise productivity, silver chloride is preferably added to aqueous ammonia and dissolved therein. As the aqueous ammonia to dissolve silver chloride, ordinary aqueous ammonia for industrial use may be used, but aqueous ammonia having purity as high as possible is preferably used in order to prevent impurities from being mixed in.

Next, a reducing agent solution to be mixed with the silver complex solution is prepared. Common hydrazine, formalin, or the like may be used as a reducing agent. Particularly, ascorbic acid is preferably used because the reducing process of ascorbic acid is mild and accordingly crystalline particles in silver particles easily grow. Hydrazine and formalin have strong reducing power, and therefore crystals in silver particles easily become small. Furthermore, in order to control reaction uniformity or reaction rate, there may be used an aqueous solution whose concentration is adjusted by dissolving or diluting a reducing agent with pure water or the like.

To this reducing agent solution, an organic compound having a hydrophilic group which is positively charged when ionized in water is added. When an organic compound having a hydrophilic group which is positively charged when ionized in water is added to the reducing agent solution, the organic compound adsorbs onto the surfaces of silver particles since the surfaces of the silver particles are in a negative state under alkaline environment. Therefore, when an organic compound having a hydrophilic group which is positively charged when ionized in water is present at the time of the reduction, the organic compound adsorbs onto the surfaces of silver particles before chlorine adsorbs since the organic compound has a hydrophilic group which is to be positively charged. Thus, bonding of the organic compound to the surfaces of silver particles precedes bonding of chlorine thereto, whereby adsorption of chlorine onto silver particles can be controlled. Therefore, since a less amount of chlorine adsorbs onto silver particles, silver powder to be obtained through downstream steps has a lower content of chlorine. Moreover, the organic compound bound to silver particles allows a dispersant added later to strongly bind to the silver particles.

As an organic compound, a cationic surface active agent can be mentioned, specifically, the cationic surface active agent is any one of or a mixture of any of a quaternary ammonium salt, a tertiary amine salt, and a polyamine compound having two or more amino groups in a molecule. When a quaternary ammonium salt, a tertiary amine salt, or a polyamine compound having two or more amino groups in a molecule is used, compares with the case where another organic compound is added, a dispersant mentioned later strongly binds to silver particles, and therefore the silver particles have excellent dispersibility.

An organic compound is preferably added in an amount of 0.0005% by mass to 5.0% by mass with respect to an amount of silver. When an organic compound is added in an amount within this range, 50% or more of the amount of the organic compound added adsorbs to silver particles although the adsorption amount of the organic compound onto silver particles varies depending on a type of the organic compound, and thus adsorption of chlorine onto silver particles can be controlled.

As mentioned above, an organic compound having a hydrophilic group which is positively charged when ionized in water is added to a reducing agent solution, whereby an amount of chlorine contained in silver powder can be controlled to 0.003% or less by mass.

Furthermore, the organic compound only has to be added at the time of the reduction, and accordingly the addition thereof is not limited to the addition to a reducing agent solution beforehand, and the organic compound may be added beforehand to both a silver complex solution and a reducing agent solution or to a silver complex solution, and also may be added at the time of mixing a silver complex solution with a reducing agent solution, however, the organic compound is hard to supply at the stage of nucleation or nucleus growth, and thus there is a risk that the organic compound poorly adsorbs onto the surfaces of silver particles. Therefore, as mentioned above, it is preferable to add the organic compound to a reducing agent solution beforehand. In this way, the organic compound is present at the stage of nucleation or nucleus growth, whereby it becomes possible to make the organic compound quickly adsorb onto the surfaces of the formed nuclei or silver particles, to control adsorption of chlorine, and to achieve the lower content of chlorine in silver powder.

Furthermore, in order to control aggregation of silver particles, a water soluble polymer may be added to a reducing agent solution. When a water soluble polymer is not added thereto, nuclei resulting from reduction and silver particles resulting from nucleus growth aggregate, thereby causing poor dispersibility thereof. On the other hand, excessive addition of a water soluble polymer causes too much amount of the water soluble polymer t, whereby the wiring layer, the electrode, and the like, each being formed with a conductive paste containing silver powder having a high content of the water soluble polymer cannot have sufficient conductivity. The amount of a water soluble polymer added is suitably determined depending on the type of the water soluble polymer and the particle diameter of target silver powder, but preferably within a range of 0.1 to 20% by mass with respect to the amount of silver contained in a silver complex solution, more preferably within a range of 1 to 20% by mass.

The water soluble polymer to be added is particularly not limited, but preferably at least one kind selected from polyethylene glycol, polyvinyl alcohol, polyvinyl pyrrolidone, gelatin, and the like, more preferably at least one kind selected from polyethylene glycol, polyvinyl alcohol, and polyvinyl pyrrolidone. In particular, these water soluble polymers can effectively prevent aggregation of silver particles and achieve higher dispersibility of silver particles.

A water soluble polymer may be added to both a silver complex solution and a reducing agent solution or to a silver complex solution prior to a reduction treatment, or also may be added at the time of mixing of a silver complex solution with a reducing agent solution for a reduction treatment, but, in this case, the water soluble polymer is hard to supply at the stage of nucleation or nucleus growth, and thus there is a risk that the water soluble polymer cannot adsorb onto the surfaces of silver particles. Therefore, as mentioned above, it is preferable to add a water soluble polymer to a reducing agent solution beforehand. In this way, the water soluble polymer is present at the stage of nucleation or nucleus growth, whereby it becomes possible to make the water soluble polymer quickly adsorb onto the surfaces of the formed nuclei or silver particles, to efficiently control the formation of an aggregation, and to produce silver powder having good dispersibility.

When a water soluble polymer is added, it sometimes foams at the time of a reduction reaction, and therefore a defoaming agent may be added to a silver complex solution or a mixed solution of reducing agent. The defoaming agent is not particularly limited and may be a defoaming agent commonly used at the time of reduction. However, it should be noted that, in order not to inhibit a reduction reaction, the amount of a defoaming agent added is preferably a minimum amount required to achieve defoaming effects.

The water used for preparation of a silver complex solution and a reducing agent solution is preferably water from which impurities have been removed, more preferably pure water, in order to prevent impurities from being mixed in.

Next, a reduction process is performed, the reduction process being such that the silver complex solution and the reducing agent solution which are prepared as mentioned above are mixed to reduce a silver complex and thereby to precipitate silver particles. A batch method may be employed for this reduction reaction, and also a continuous reduction method, such as a tube reactor method or an overflow method, may be employed. In order to obtain silver particles having a uniform particle diameter, a tube reactor method is preferably used since it can easily control particle growth time. Furthermore, the particle diameter of silver particles can be controlled by a mixing rate of a silver complex solution and a reducing agent solution or a reduction rate of a silver complex, whereby the particle diameter of silver particles can be easily controlled to a target particle diameter. The silver particles have a mean particle diameter of approximately 0.1 μm to 1.5 μm, and the mean particle diameter is suitably adjusted depending on the diameter of a wire to be formed or the thickness of the electrode to be formed.

Next, a surface treatment is performed for the obtained silver particles. This surface treatment is preferably performed before the silver particles onto which the above-mentioned organic compound and the above-mentioned water soluble polymer adsorb are washed by using an alkaline solution or water. Washing the silver particles with an alkaline solution or water causes the water soluble polymer adsorbing onto the surfaces of the silver particles to be easily removed, and therefore the silver particles aggregate in a portion in which the water soluble polymer has been removed. Therefore, when the surface treatment is performed after the washing, the surfaces of the aggregating silver particles are subject to the surface treatment, and thus a surface thereof not subject to the surface treatment is revealed by pulverizing after drying, thereby causing the unevenness of the surface treatment, which is not preferable. Therefore, a surface treatment before washing is preferable.

The surface treatment is performed in such a manner that a dispersant is added to silver particle slurry containing silver particles thereby to make the silver particles onto which the above-mentioned organic compound adsorbs bind to the dispersant. In particular, using the cationic surface active agent allows the dispersant to bind to the cationic surface active agent combined with the surfaces of the silver particles, whereby a firm surface-treated layer (coating layer) is formed on the surfaces of the silver particles owing to an interaction of the dispersant with the cationic surface active agent. This surface-treated layer is highly effective in prevention of aggregation of silver particles. In the case of using a quaternary ammonium salt or a tertiary amine salt among cationic surface active agents, the surface active agent more firmly binds to a dispersant, and thus the surface-treated layer more firmly binds to silver particles.

As the dispersant, for example, a protective colloid, such as fatty acid, organic metal, or gelatin, may be used, but, taking into consideration a risk of impurity and the adsorptivity to a surface active agent, fatty acid or a salt thereof is preferably used. Furthermore, as the dispersant, there is preferably used what is obtained by emulsifying fatty acid or a salt thereof with a surface active agent, and the surface treatment by the dispersant allows fatty acid and the surface active agent to bind to the surfaces of silver particles, whereby dispersibility of the silver particles can be further improved.

Fatty acid t used as the dispersant is not particularly limited, but preferably at least one kind selected from stearic acid, oleic acid, myristic acid, palmitic acid, linoleic acid, lauric acid, and linolenic acid. This is because these kinds of fatty acid have a comparatively low boiling point and thus have less adverse effects on the wiring layer and the electrode which are formed by using the silver paste.

Moreover, the additive amount of a dispersant is preferably in a range of 0.01 to 1.00% by mass with respect to the amount of silver particles. As the case with the above-mentioned organic compound, the dispersant varies in the amount of adsorption to the silver particles depending on the type of the dispersant, but, when the additive amount of the dispersant is less than 0.01% by mass, in order to control the aggregation of silver particles and to improve the adsorptivity of the dispersant, the enough amount of the dispersant may not adsorb to silver powder. On the other hand, when the additive amount of a dispersant is more than 1.00% by mass, too much amount of the dispersant adsorbs silver particles, and therefore the wiring layer, the electrode, and the like, each being formed with the silver paste, may not achieve sufficient conductivity.

Furthermore, in the case when an organic compound other than a cationic surface active agent is added to the above-mentioned reducing agent solution and/or the above-mentioned silver complex solution, the surface treatment is preferably performed in such a manner that a cationic surface active agent is added together with a dispersant to silver particle slurry in order to form a firm surface-treated layer. Furthermore, even in the case when a cationic surface active agent is added to the reducing agent solution and/or the silver complex solution as mentioned above, a surface active agent may be added together with a dispersant in the surface treatment. The surface treatment using both a surface active agent and a dispersant allows silver particles to have a higher affinity for a solvent in the paste, whereby silver powder having good dispersibility in the paste can be produced.

The surface active agent is not particularly limited, but preferably a cationic surface active agent. The cationic surface active agent is not particularly limited, but preferably at least one kind selected from alkyl monoamine salts, typified by monoalkylamine salts; alkyl diamine salts, typified by N-alkyl (C14-C18) propylenediamine dioleate; alkyl trimethyl ammonium salts, typified by alkyl trimethyl ammonium chloride; alkyl dimethyl benzyl ammonium salts, typified by alkyl dimethyl benzyl ammonium chloride; quaternary ammonium salts, typified by alkyl dipolyoxyethylene methyl ammonium chloride; alkyl pyridinium salts; tertiary amine salts, typified by dimethylstearylamine; polyoxyethylene alkylamine, typified by polyoxypropylene polyoxyethylene alkylamine; and diamine oxyethylene adducts, typified by N,N′,N′-tris (2-hydroxyethyl)-N-alkyl (C14-18)1,3-diaminopropane, and more preferably any one of or a mixture of any of a quaternary ammonium salt, a tertiary amine salt, and a polyamine compound having two or more amino groups in a molecule.

Furthermore, the surface active agent preferably has at least one alkyl group with a carbon number of C4 to C36, typified by a butyl group, a cetyl group, a stearyl group, beef tallow, hardened beef tallow, and a plant-based stearyl, additionally a methyl group with a different carbon number. There is preferably an alkyl group to which at least one kind selected from polyoxyethylene, polyoxypropylene, polyoxyethylene polyoxypropylene, polyacrylic acid, and polycarboxylic acid is added. These alkyl groups can strongly adsorb to later-mentioned fatty acid used as a dispersant, and therefore, when a dispersant is made to adsorb onto silver particles via a surface active agent, fatty acid can strongly adsorb thereonto.

Furthermore, the additive amount of a surface active agent is preferably within a range of 0.002 to 1.000% by mass with respect to the amount of silver particles. By adding the amount of a surface active agent within the above-mentioned range, the surface active agent can sufficiently adsorb onto the surfaces of silver particles. When the additive amount of a surface active agent is less than 0.002% by mass, the effects of aggregation control of silver particles or adsorptivity improvement of a dispersant sometimes cannot be obtained. On the other hand, when the additive amount of a surface active agent is more than 1.000% by mass, too much amount of the surface active agent adsorb onto silver particles, and therefore conductivity of the wiring layer, the electrode, and the like, each being formed with the silver paste, may be decreased. Adsorption of a surface active agent onto silver particles allows dispersibility of the silver particles in the silver paste to improve and the wiring layer and the electrode formed with the silver paste to achieve sufficient conductivity.

As an apparatus to be used for washing and the surface treatment of silver particles, an apparatus commonly used is beneficial, for example, a reaction vessel with a stirrer, or the like may be used.

Next, a washing process for washing the surface-treated silver particles is performed. Impurities and an excessive amount of a water soluble polymer adsorb onto the surfaces of silver particles. Therefore, in order to achieve sufficient conductivity of the wiring layer, the electrode, and the like, each being formed with the silver paste, it is necessary to wash the obtained silver particle slurry and thereby to remove impurities adhering to silver particles and a water soluble polymer excessively adhering thereto. Even if the impurities and the water soluble polymer are removed, the surface-treated layer remains, whereby both aggregation control of silver particles and high conductivity of the wiring layer, the electrode, and the like can be achieved.

A washing method commonly used is such that silver particles separated from silver particle slurry by solid-liquid separation are fed into a washing liquid and stirred using a stirrer or an ultrasonic washer, and then solid-liquid separation is performed again to collect silver particles. Furthermore, in order to sufficiently remove a surface adsorbate, there is preferably repeated several times an operation being such that silver particles are fed into a washing liquid and then stirred and washed, followed by solid-liquid separation.

As the washing liquid, an alkaline solution or water is used in order to efficiently remove a water soluble polymer and impurities, each adsorbing onto the surfaces of silver particles. As the alkaline solution, there may be used any one of or a mixture of any of a sodium hydroxide solution, a potassium hydroxide solution, a calcium hydroxide solution, and aqueous ammonia. Besides, there is no problem with using an alkaline solution comprising an inorganic compound or an organic compound. As the water used as a washing liquid, pure water is more preferable since the water containing an impurity element is harmful to silver particles.

The alkaline solution preferably has a concentration of 0.01% by mass to 20% by mass. An alkaline solution having a concentration of less than 0.01% by mass causes insufficient washing effects, on the other hand, an alkaline solution having a concentration of more than 20% by mass causes an alkali metal salt to remain in silver particles, more than allowed. Therefore, in the case when the alkaline solution having a high concentration is used, it is necessary to perform sufficient washing with pure water after washing with the alkaline solution and thereby to control the remaining of an alkali metal salt.

After the washing, solid-liquid separation is performed to collect silver particles. As the apparatus to be used for solid-liquid separation, an apparatus commonly used is beneficial, and for example, a centrifuge, a suction filter, a filter press, or the like may be used.

Next, in a drying process, moisture contained in the separated silver particles is evaporated to dry the silver particles. The drying method is such that, for example, silver powder collected after completion of washing and the surface treatment is placed on a stainless steel pad, and heated at a temperature of 40 degrees C. to 80 degrees C., using a commercially available dryer, such as an air oven or a vacuum dryer.

Next, silver particles obtained after drying are lightly pulverized to loosen an aggregation produced at the time of drying. The pulverizing may be performed if it is necessary to loosen an aggregation in silver particles obtained after drying. The pulverizing can be performed with weak power. The reason for this is that aggregation of the silver particles is controlled by the surface treatment. As a power for the pulverizing, there may be a small vibration, for example, the same level of a vibration created when silver particles are sieved with a gyroshifter.

After the above-mentioned pulverizing, classification is performed, whereby silver powder having a desired particle-size distribution can be obtained. A classification apparatus to be used in the classification is not particularly limited, and an airflow classifier, a sieve, or the like may be used.

Thus, in the above-mentioned method for producing the silver powder, in the case when an organic compound having a hydrophilic group which is positively charged when ionized in water is added to a reducing agent solution, or when an organic compound is added to both a silver complex solution and a reducing agent solution or only to a silver complex solution, the organic compound coexists at the time of reduction, and accordingly the organic compound adsorbs onto the surfaces of silver particles prior to chlorine does. Thus, according to the method for producing silver powder, the organic compound has already adsorbed onto the surfaces of silver particles, and therefore adsorption of chlorine onto the silver particles is controlled, whereby silver powder produced has a chlorine content of 0.003% or less by mass. Therefore, even in the case when silver chloride is used instead of using silver nitrate as a starting material, silver powder having a lower content of chlorine can be produced without employing special equipment. Furthermore, the above-mentioned method for producing silver powder does not use silver nitrate as a raw material, and accordingly, even taking into consideration nitrate ions which are unavoidably mixed in owing to the presence of impurities and the like, the amount of nitrate ions detected by time-of-flight secondary ion mass spectrometry is five or less times as much as the amount of silver negative ions detected. When the amount of nitrate ions detected is more than 5 times, in the formation of the wiring layer, the electrode, and the like of electronic components by using the silver powder as the silver paste, nitric acid may be discharged, whereby electronic components may be degraded owing to corrosion.

Furthermore, a conductive paste obtained by mixing the above-mentioned silver powder having a lower content of chlorine with glass, the solvent, and the like has good sintering characteristics of silver powder, and therefore the wiring layer, the electrode, and the like, each having good conductivity, can be formed. Also for this conductive paste, the silver powder obtained by the above-mentioned method for producing silver powder is used, and therefore, as the case with the silver powder, the amount of nitrate ions detected is not more than five times as much as the amount of silver negative ions detected.

### EXAMPLES

Hereinafter, specific examples according to the present invention will be explained. It should be noted that the present invention is not limited to the following examples.

### Example 1

While being stirred, 2918 g of silver chloride (manufactured by Sumitomo Metal Mining Co., Ltd.) was fed into 40 L of 25% aqueous ammonia maintained at a liquid temperature of 36 degrees C. in a warm bath having a temperature of 38 degrees C., whereby a silver complex solution was prepared, and the obtained silver complex solution was maintained at a temperature of 36 degrees C. in a warm bath.

Meanwhile, 1220 g of ascorbic acid (reagent, manufactured by KANTO CHEMICAL Co., Inc.) as a reducing agent was dissolved in 14 L of pure water having a temperature of 36 degrees C., whereby the reducing agent solution was prepared.

Next, 106.8 g of polyvinyl alcohol (PVA205, manufactured by KURARAY Co., Ltd.) as a water soluble polymer was dissolved in 550 ml of pure water having a temperature of 36 degrees C., and then mixed with the reducing agent solution, and furthermore, 1.2 g of polyoxyethylene addition quaternary ammonium salt (Cirrasol G-265, manufactured by Croda Japan KK, 0.054% by mass with respect to the amount of silver contained in the silver complex solution) as a cationic surface active agent was mixed with the reducing agent solution.

Using a pump (manufactured by HEISHIN Ltd.), the prepared silver complex solution and the prepared reducing agent solution were sent to a mixing pipe at 2.7 L/min and 0.9 L/min, respectively, whereby the silver complex was reduced. A polyvinyl chloride pipe having an inside diameter of 25 mm and a length of 725 mm was used as the mixing pipe. While being stirred, slurry which contains the silver particles obtained by the reduction of the silver complex was fed into a receiving tank.

After that, 19.5 g of stearate emulsion (Selosol 920, manufactured by Chukyo Yushi Co., Ltd., 1.0% by mass with respect to the amount of silver particles) as a dispersant was fed into the silver particle slurry obtained by the reduction, and stirred for 60 minutes to perform the surface treatment. After the surface treatment, the silver particle slurry was filtered by using a filter press, whereby silver particles were solid-liquid separated.

Then, before the collected silver particles dried, the silver particles were fed into 23 L of 0.2% by mass of a sodium hydroxide (NaOH) solution maintained at a temperature of 40 degrees C., and stirred for 15 minutes and washed, and then filtered with the filter press to collect silver particles.

Next, the collected silver particles were fed into 23 L of pure water maintained at a temperature of 40 degrees C., stirred, and filtered, and then, the silver particles were transferred to a stainless steel pad and dried at a temperature of 60 degrees C. for 10 hours, by using a vacuum dryer. Then, the dried silver particles were pulverized using a 5L high-speed stirrer (FM5C, manufactured by NIPPON COKE & ENGINEERING Co., Ltd.). After the pulverizing , by using an airflow classifier (EJ-3, manufactured by Nittetsu Mining Co., Ltd.,), the silver particles were classified at a classification point of 7 μm to remove coarse particles therefrom, whereby the silver particles were obtained.

By using 3 ml of 50% by volume of a nitric acid solution, 0.5 g of the obtained silver particles were decomposed, and furthermore, 0.05 g of potassium bromide was added thereto to form a mixture of silver chloride and silver bromide, then 5 ml of 10% by mass of a sodium borohydride solution was poured into this mixture obtained by filtering, whereby silver chloride was reduced to be separated into silver and chloride ions. The resulting solution was analyzed by an ion chromatograph (ICS-1000, manufactured by Thermo Fischer Scientific K.K.), and as a result, the solution had a chlorine content of 0.0013% by mass. The content of nitrate ions was analyzed by time-of-flight secondary ion mass spectrometry which was performed with TOF-SIMS (TOF-SIMS5, manufactured by ION-TOF Gmbh), using bismuth as primary ions and applying an accelerating voltage of 25 kV, and as a result, in terms of the detection amount of negative secondary ions, the amount of nitrate ions having an M/Z (mass-to-charge ratio) of 62 was less than that of silver negative ions having an M/Z of 107. In other words, it is understood that the content amount of nitrate ions was very small taking into consideration the fact that, in silver, his originally positive when ionized, silver negative ions are secondarily detected in trace amounts.

Furthermore, in SEM observation, by measuring 300 or more silver particles, it is understood that the silver powder had a mean particle diameter DS of 1.07 μm. Furthermore, the silver powder was dispersed in isopropyl alcohol and measured by laser diffraction scattering, and as a result, the silver powder had a volume-integral mean particle diameter D50 of 2.1 μm. Furthermore, the specific surface area of the silver powder measured by the BET method was 0.42 m²/g.

### Example 2

Silver particles were obtained and evaluated in the same manner as in Example 1, except that, in Example 2, the cationic surface active agent was changed to a tertiary amine salt (NYMEEN L207, manufactured by NOF CORPORATION). As a result, the silver powder had a chlorine content of 0.0021% by weight. Furthermore, the silver powder had a mean particle diameter DS of 1.01 μm. Furthermore, the silver powder was dispersed in isopropyl alcohol and measured by laser diffraction scattering, and as a result, the silver powder had a volume-integral mean particle diameter D50 of 2.0 μm. Furthermore, the specific surface area of the silver powder measured by the BET method was 0.45 m²/g.

### Example 3

Silver particles were obtained and evaluated in the same manner as in Example 1, except that, in Example 3, the cationic surface active agent was changed to a polyamine compound having two or more amino groups in a molecule (BYK9076, manufactured by BYK), and the polyamine compound was added as an ethanol solution. As a result, the silver powder had a chlorine content of 0.0015% by weight. Furthermore, the silver powder had a mean particle diameter DS of 0.98 μm. Furthermore, the silver powder was dispersed in isopropyl alcohol and measured by laser diffraction scattering, and as a result, the silver powder had a volume-integral mean particle diameter D50 of 2.0 μm. Furthermore, the specific surface area of the silver powder measured by the BET method was 0.46 m²/g.

### Comparative Example 1

The silver particles were produced in the same manner as in Example 1, except that, in Comparative Example 1, a cationic surface active agent was not added to the reducing agent solution, a polyoxyethylene addition quaternary ammonium salt as a cationic surface active agent was fed into the silver particle slurry obtained by the reduction, and then, a stearate emulsion was fed thereinto as a dispersant.

The obtained silver powder was evaluated in the same manner as in Example 1, and as a result, the silver powder had a chlorine content of 0.0038% by weight. As for nitrate ions, in terms of the detection amount of negative secondary ions, the amount of nitrate ions having an M/Z of 62 was less than the amount of silver negative ions having an M/Z of 107.

Furthermore, the mean particle diameter DS, measured by SEM observation, of the silver powder was 1.02 μm. Furthermore, the silver powder was dispersed in isopropyl alcohol and measured by laser diffraction scattering, and as a result, the silver powder had a volume-integral mean particle diameter D50 of 2.5 μm. Furthermore, the specific surface area SSA₁ of the silver powder measured by the BET method was 0.42 m²/g.

As mentioned above, in Comparative Example 1, the content of chlorine was 0.0038% by mass, which was more than the content of chlorine in Example 1, that is, 0.0013% by mass.

### Comparative Example 2

In Comparative Example 2, while being stirred, 900 g of silver nitrate (reagent, manufactured by KANTO CHEMICAL Co., Inc.) was fed into 50 L of 10% aqueous ammonia maintained at a liquid temperature of 36 degrees C. in a warm bath having a temperature of 38 degrees C., whereby a silver complex solution was prepared, and the obtained silver complex solution was maintained at a temperature of 36 degrees C.

Meanwhile, 170 ml of hydrazine monohydrate (manufactured by KANTO CHEMICAL Co., Inc.) as a reducing agent was diluted in 14 L of water to prepare a reducing agent solution.

Next, 100 g of polyvinyl alcohol (PVA205, manufactured by KURARAY Co., Ltd.) as a water soluble polymer was dissolved in 550 ml of pure water having a temperature of 36 degrees C., and then mixed with the reducing agent solution.

By using a pump (manufactured by HEISHIN Ltd.), the prepared silver complex solution and the prepared reducing agent solution were sent to a mixing pipe at 2.7 L/min and 0.9 L/min, respectively, whereby the silver complex was reduced. A polyvinyl chloride pipe having an inside diameter of 25 mm and a length of 725 mm was used as the mixing pipe. While being stirred, slurry containing the silver particles obtained by the reduction of the silver complex was fed into a receiving tank.

After that, 6 g of stearate emulsion (Selosol 920, manufactured by Chukyo Yushi Co., Ltd., 1.0% by mass with respect to the amount of silver particles) as a dispersant was fed into the silver particle slurry obtained by the reduction, and stirred for 60 minutes to perform a surface treatment. After the surface treatment, the silver particle slurry was filtered by using the filter press, whereby the silver particles were solid-liquid separated.

Then, before the collected silver particles dried, the silver particles were fed into 23 L of 0.2% by mass of a sodium hydroxide (NaOH) solution maintained at a temperature of 40 degrees C., stirred for 15 minutes, and washed, and then filtered by using the filter press to collect silver particles.

Next, the collected silver particles were fed into 23 L of pure water maintained at a temperature of 40 degrees C., stirred, and filtered, and then, the silver particles were transferred to the stainless steel pad and dried at a temperature of 60 degrees C. for 10 hours, by using a vacuum dryer. Then, the dried silver particles were pulverized by using a 5L high-speed stirrer (FM5C, manufactured by NIPPON COKE & ENGINEERING Co., Ltd.). After the pulverizing, by using an airflow classifier (EJ-3, manufactured by Nittetsu Mining Co., Ltd.), the silver particles were classified at a classification point of 7 μm to remove coarse particles therefrom, whereby silver particles were obtained.

The obtained silver powder was evaluated in the same manner as in Example 1, and as a result, the silver powder had a chlorine content of 0.0008% by mass. As for nitrate ions, in terms of the detection amount of negative secondary ions, the amount of nitrate ions having an M/Z of 62 was 30 times as much as that of silver negative ions having an M/Z of 107.

In Example 1 to Example 3, a cationic surface active agent having a hydrophilic group which was positively charged when ionized in water was beforehand added to a reducing agent solution, and the reducing agent solution was mixed with a silver complex solution to carry out reduction, and therefore the cationic surface active agent coexisted at the time of the reduction. Thus, in Example 1, adsorption of the cationic surface active agent onto the surfaces of silver particles precedes adsorption of chlorine thereonto, whereby adsorption of chlorine onto silver particles was controlled, and therefore the amount of chlorine contained in the silver powder was reduced. Moreover, the silver powder had a good particle size for pastes.

On the other hand, in Comparative Example 1, a cationic surface active agent was added to silver particle slurry after reduction, and therefore chlorine adsorbed onto silver particles, and thus a more amount of chlorine was contained in silver powder. Furthermore, in Comparative Example 2, silver nitrate was used as a raw material, whereby a less amount of chlorine was contained, but a more amount of nitrate ions, which cause corrosion of electronic components at the time of sintering, were contained.

Hence, it is understood that, in production of silver powder, an organic compound having a hydrophilic group which is positively charged when ionized in water is added to a reducing agent solution in such a way as to make the organic compound coexist at the time of reduction, whereby the organic compound preferentially adsorbs onto the surfaces of the silver particles while adsorption of chlorine thereonto is controlled, and thus the amount of chlorine contained in the silver powder can be reduced. Furthermore, in the production of silver powder, silver chloride was used as a starting material, and therefore nitrate ions were not contained in the silver powder.

1. A method for producing silver powder, the method being such that a solution containing a silver complex obtained by dissolving silver chloride with a complexing agent is mixed with a reducing agent solution and the above-mentioned silver complex is reduced,
wherein an organic compound having a hydrophilic group which is positively charged when ionized in water is added to both the solution containing the silver complex and the reducing agent solution, or added to either the solution containing the silver complex or the reducing agent solution.

2. The method for producing silver powder according to claim 1, wherein the above-mentioned organic compound is added to the above-mentioned reducing agent solution.

3. The method for producing silver powder according to claim 1, wherein the above-mentioned organic compound is a cationic surface active agent.

4. The method for producing silver powder according to claim 3, wherein the above-mentioned cationic surface active agent is any one of or a mixture of any of a quaternary ammonium salt, a tertiary amine salt, and a polyamine compound having two or more amino groups in a molecule.

5. The method for producing silver powder according to claim 1, wherein the above-mentioned organic compound is added in an amount of 0.0005% by mass to 5.0% by mass with respect to an amount of silver.

6. Silver powder, wherein an organic compound having a hydrophilic group which is positively charged when ionized in water adsorbs onto surfaces of silver particles, and a concentration of chlorine is 0.003% or less by mass.

7. The silver powder according to claim 6, wherein an amount of nitrate ions detected by time-of-flight secondary ion mass spectrometry is not more than five times as much as an amount of silver negative ions detected thereby.

8. A conductive paste, containing silver powder as a conductor,
the silver powder wherein an organic compound having a hydrophilic group which is positively charged when ionized in water adsorbs onto surfaces of silver particles, and a concentration of chlorine is 0.003% or less by mass.

9. The conductive paste according to claim 8, wherein an amount of nitrate ions detected by time-of-flight secondary ion mass spectrometry is not more than five times as much as an amount of silver negative ions detected thereby.
